(19) United States
(12) Patent Application Publication
(10) Pub. No.: US 2009/0195882 A1
(43) Pub. Date: Aug. 6, 2009

(54) Mechanical lenses

(76) Inventors: Cristian A. Bolle, Bridgewater, NJ (US); Roland Ryf, Aberdeen, NJ (US); Maria Elina Simon, New Providence, NJ (US)

Correspondence Address: Docket Administrator - Room 2F-192;Alcatel-Lucent USA Inc., 600-700 Mountain Avenue, Murray Hill, NJ, 07974, US

(21) Appl. No.: 12/012,772

(22) Filed: Feb. 5, 2008

(51) Int. Cl. G02B 3/12

(52) U.S. Cl. 359/665

(57) ABSTRACT

A mechanical lens includes a rigid chamber, a first transparent window located to close one end of the chamber, a flexible transparent membrane window located to close another end of the chamber, and a transparent fluid having an index of refraction. The flexible transparent membrane window is along an optical path of light received through said first transparent window. The chamber is filled with said fluid and a curvature of said flexible transparent membrane window is responsive to a pressure of said transparent fluid.

### BACKGROUND

1. Field of the Invention

The present invention relates to mechanical optical lenses and to methods of operating such lenses.

2. Discussion of the Related Art

This section introduces aspects that may help facilitate a better understanding of the inventions. Accordingly, the statements of this section are to be read in this light and are not to be understood as admissions about what is prior art or what is not prior art.

Presently in the commercial arena, there are two major categories of optical lenses, i.e., refractive lenses and/or reflective lenses. An example of a reflective lens is shown in FIG. 1 and an example of a refractive lens is shown in FIG. 2.

Such lenses find applications in different fields all the way from scientific applications such as astronomy or optical microscopy, to consumer applications such as photographic or cinematographic cameras.

For example, the reflective lens shown in FIG. 1 is suitable for an optical telescope for astronomy. The incoming light coming from a far away object comes in as a plane wave, represented by parallel light rays in the figure. The primary mirror (101) is typically of large dimensions, up to several meters. There is a drawback to such a configuration, in that the light falling on the backside of the secondary mirror (100) is lost and will not contribute to the image rendered by the telescope. However there is an advantage also, in that such a configuration does not introduce any chromatic dispersion or chromatic aberration. If the diameter of the primary mirror is much greater than the diameter of the secondary mirror, then the light loss from the shadow of the secondary mirror becomes negligible.

The optical transmission characteristics (optical transfer function or OTF) of such a reflector lens are determined by the curvature of the primary mirror (101) and the distance between the primary mirror (101) and the secondary mirror (100). In practice, the curvature of the primary mirror (101) may not be changed after manufacture, so the only adjustable parameter is the distance between the two mirrors. The curvature of the primary mirror will be tuned to focus at a certain distance, for example focus to infinity. This would typically be a fine adjustment, only for optimizing the focus of the lens.

The lens array shown in FIG. 2 is a typical refractive lens such as may be found in a high quality photographic camera. Such a camera lens is composed of a number of many individual lenses (201, 202, 203, 204, 205, 206, . . . ) placed in an array along the optical axis of the incoming light. Some of the individual elements may be stationary, others may be mobile, for example to focus or zoom. Some may be glued together to form an optical block. The relevant parameters of such a lense are the refractive index of the glass used for each element, the shape of each element, and finally, the distance between the various elements. The shape and index of refraction of each element obviously cannot be changed once manufactured; only the relative distance between elements may be varied. As there are a number of elements aligned along the optical axis, the lens may become quite cumbersome. Another drawback is that each successive element will introduce chromatic aberration and/or distortions, which then require additional lens elements for correction of those chromatic aberrations and/or distortions. Thus the final compound lens is often not very compact.

### SUMMARY

Various embodiments include a mechanical lens whose shape may be adjusted by external control system. In some embodiments, the mechanical lens has a shape that can be varied while in use. In such embodiments, the shape may be dynamically changed by the external control system to allow a real time manipulation of the optical transfer function (OTF) of the lens. Some such apparatus include two such lenses having different indices of refraction in a single optical block. In some embodiments, the external control system can be an electromechanical system.

In one aspect, a mechanical lens includes a rigid chamber, a first transparent window located to close one end of the chamber, a flexible transparent membrane window located to close another end of the chamber, and a transparent fluid having an index of refraction. The flexible transparent membrane window is along an optical path of light received through said first transparent window. The chamber is filled with said fluid and a curvature of said flexible transparent membrane window is responsive to a pressure of said transparent fluid.

In some embodiments of the apparatus, the shape of the flexible transparent membrane window is fixed.

In some embodiments, the apparatus includes an external control system that can adjust the amount of fluid within the cavity, thus affecting the shape of the flexible transparent membrane window. The chamber may have another wall fitted with a fluid fill port that connects to the external control system. The external control system may be able to dynamically adjust the shape of the flexible transparent membrane window by varying the amount of fluid within the chamber thereby enabling a variation of the optical transmission characteristics in real time.

An appreciation of the aims and objectives of some embodiments of the present invention and a more complete and comprehensive understanding of these embodiments may be achieved by studying the following description of preferred embodiments and by referring to the accompanying drawings.

### BRIEF DESCRIPTION OF THE DRAWINGS

In the figures, the same reference numbers refer to the same elements in the different embodiments exposed as examples. The scale of the drawings may not be strictly respected in order to make the drawings easier to read and to understand. All of the drawings are presented as viewed in a median plane, containing an axis of symmetry aligned with the direction of light propagation through the device.

FIG. 1 represents a typical folded reflector lens.

FIG. 2 represents a typical refractive lens assembly.

FIG. 3 is a schematic cutaway view of an embodiment of a mechanical lens according to one embodiment.

FIGS. 4A and 4B are cross section views of different geometries of flexible membranes which may be used to realize different embodiments.

FIG. 5 is a schematic cutaway view of another embodiment of a mechanical lens according to one embodiment.

FIG. 6 is a schematic cutaway view of another embodiment of a mechanical lens having two chambers filled with fluids of different indices of refraction.

FIG. 7 is a schematic cutaway view of another embodiment of a mechanical lens that has two chambers filled with fluids of different indices of refraction and also has two flexible transparent membranes.

FIG. 8 is a schematic cutaway view of another embodiment of a mechanical lens having two chambers filled with fluids of different indices of refraction and also has a flexible transparent membrane and rigid bulk optical element.

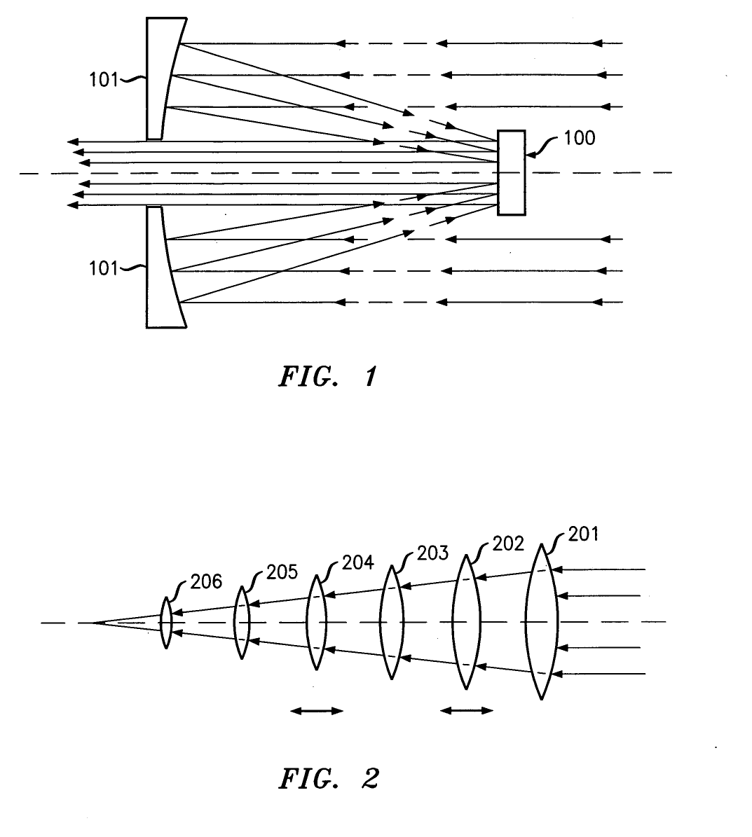

### DETAILED DESCRIPTION OF PREFERRED EMBODIMENTS

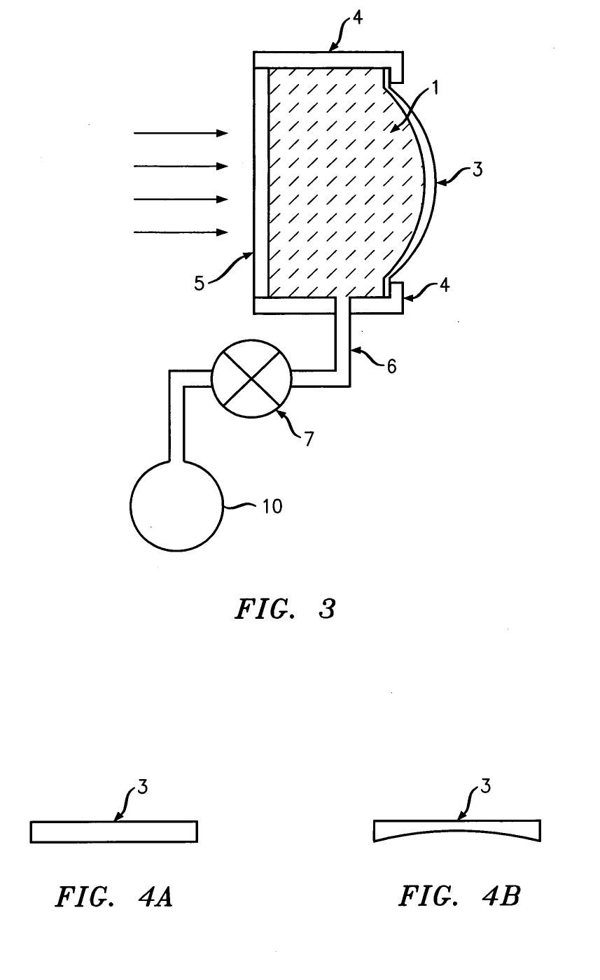

FIG. 3 shows one embodiment of a mechanical lens. The mechanical lens comprises a rigid chamber (4) that is closed on at least one end by at least one flexible transparent membrane window (3) and is filled with a transparent fluid (1) having an index of refraction. The expression “transparent fluid” means a liquid or a gas, wherein the liquid or gas is “transparent to a wavelength range of interest”. The wavelength range could be a near-IR wavelength band, the visible light wavelength band, a portion of the visible light wavelength band, e.g., blue light or red light, a radio wavelength band, etc. The flexible transparent membrane window (3) may also be elastic to enable reversible changes to the shape of the surface of the flexible transparent membrane window (3) in response to changes in the pressure applied in the adjacent fluid (1). That is, the surface can take on various convex and concave shapes.

Exemplary flexible transparent membrane windows (3) may be manufactured by micromachining techniques. Some such windows may be formed by depositing one or more dielectric films, e.g., a layer of about ½ micron to about 5 microns of silicon nitride, on a standard microelectronics substrate, e.g., a crystalline silicon wafer-substrate or a glass wafer-substrate. Then, a conventional deep back-side etch is performed to remove the substrate below a portion of the deposited one or more dielectric films. The back-side etch leaves a frame that is pierced by a round hole to expose the underlying one or more films. In particular, the one or more films cover and seal off the round hole so that the frame functions as a holder of the transparent flexible membrane window. Then, the membrane window is attached by hermetically fixing the frame across one end of the chamber. The attaching step is performed to seal the end of the chamber to fluids. The frame may be fixed to the end of the chamber by conventional gluing, bonding, or mechanical clamping techniques. For example, the substrate may be hermetically fixed to a chamber, which has a glass end face, via conventional anodic bonding techniques. While fixing the window-supporting frame and attached membrane window across the end of the chamber, it is typically preferable to not apply large stresses to the window-supporting frame, because such stresses may adversely affect the window's ultimate shape. Such methods of fabrication may be suitable for making membrane windows with diameters of about 50 micrometers up to 10 millimeters.

Using other types of flexible transparent membrane, it is possible to increase the diameter of the lens to be in the range of about 10 to 100 centimeters. For example, such membrane windows may be formed by clamping a plastic or elastic membrane, e.g., a mylar layer, around the end of a tube with a ring and screws. The tube has a transparent end wall, i.e., a window that faces the membrane window (3). The transparent end wall forms a second window (5) and also closes the second end of the rigid chamber (4). The second window (5) and transparent flexible membrane window (3) may face each other, or more generally each of the windows (3, 5) may be located along the optical path of light rays received by the other of the windows (5, 3).

In various embodiments, the transparent membrane window (3) and the other window (5) may have one or more conventional anti-reflection coatings thereon.

In this figure, we have shown the light ray entering from the left through the window (5), but of course the light could also enter from the other side through the flexible window (3), a choice to be determined by the nature and location of the light source and the constraints of the system in which the lens will be used.

A rigid wall of the chamber (4) may be fitted with a fluid fill port (6) connected to external control system (7).

By the action of the external control system (7), the amount of fluid (1) within the cavity may be adjusted to change the shape of the transparent flexible membrane window (3). The fluid pressure on the flexible transparent membrane window (3) defines the shape of the lens.

If compared with liquid lenses, this tension can be controlled and may be larger than liquid surface tensions. Thus, the lens of various embodiments describe herein can be larger than liquid droplets.

The index of refraction of the transparent fluid (1) may be selected by the lens designer. In particular, various fluids with different optical properties, e.g., including inter alia different indexes of refraction, are known. The optical properties of some such fluids are described in the literature, for example in the CRC Handbook of Chemistry and Physics.

It may be preferable to choose a fluid (1) having the same index of refraction as the membrane window (3), or the window (5), or both. Such a selection may be more convenient for the calculation of the desired curvature of the membrane window (3), however the selection of such a special fluid is not necessary. The choice of the fluid (1) should rather be based on the desired optical properties (index of refraction) and perhaps on the fluid's mechanical properties (compressibility) and/or chemical properties such as reactivity, toxicity, or stability on the long term.

By pumping more fluid (1) into the chamber (4), the membrane (3) may be pushed further outwards, thus increasing the curvature of the resulting lens surface. On the other hand, by removing fluid (1) from the chamber, the curvature of the membrane (3) may be changed from the convex configuration as shown in FIG. 3, to a concave lens.

The flexible membrane (3) is fixed to the rigid chamber (4) by any appropriate technique to ensure that the chamber remains closed to fluid throughout the range of allowed values for the curvature of the lens. The fixation technique could be mechanical or simply involve the use of a glue.

In FIG. 3, we have shown the external control system (7) as including a valve, but it is to be understood that the external control system may include an electronic control for the valve and may also include a pump to increase the fluid pressure within the chamber, e.g., by pumping more fluid (1) therein and/or a device capable of reducing the pressure within the chamber by reducing the amount of fluid (1) contained therein. Any external control system may be used to vary the fluid pressure in the chamber. The form of the external control system may vary in different embodiments. Such an external control system may also be absent in some embodiments.

In order to supply the extra fluid (1) into the chamber, or to collect the extra fluid (1) from the chamber, the apparatus may include an optional reservoir (10). Nevertheless, such a resevoir may be absent in some embodiments and may be replaced by other devices.

The assembly of elements as shown on FIG. 3 may be used in two distinct modes which are two relevant embodiments.

In a first embodiment according to FIG. 3, the amount of fluid (1), i.e., its pressure, is adjusted to obtain a desired optical transfer function of the lens. Then, any fluid fill port (6) is sealed off. The optical transmission properties of such a mechanical lens may be thus, determined and fixed for the useful lifetime of the lens.

In a second preferred embodiment according to FIG. 3, the amount of fluid (1) is adjusted to a nominal value for the desired application, but the fluid fill port (6) is not permanently sealed off. Instead, the external control system (7) is present to allow changes to the amount of fluid (1) within the chamber (4), i.e., to allow changes to the fluid pressure, during actual use of the mechanical lens. It is envisaged that for example an electronic feedback loop could be used to control the external control system (7), according to the actual optical transfer characteristics detected and/or those which are ideally desired for a given application. These optical transmission characteristics may vary from one application to another, or may also vary with time for a given application.

FIGS. 4A and 4B show two examples of different geometries of the flexible membrane (3). More specifically, the membrane (3) may be of uniform thickness, as shown in the cross section view of FIG. 4A, or the membrane (3) may be thinner in the middle and thicker near the edges. In any case, the minimum thickness at the edges of the membrane (3) is that necessary in order to guarantee the mechanical integrity of the membrane (3), which is attached via its periphery to the chamber walls (4).

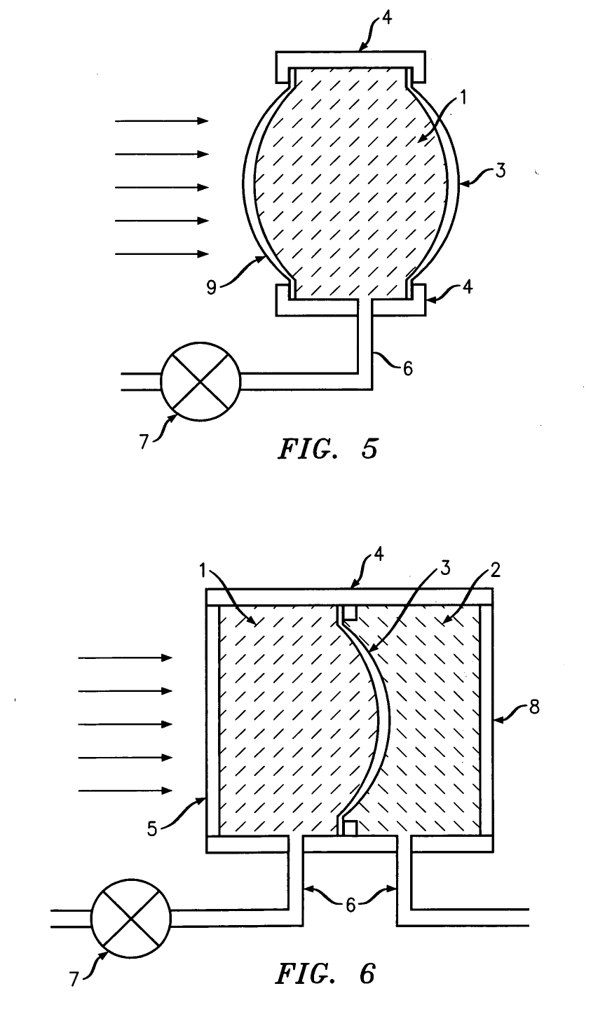

The FIG. 5 shows another embodiment, which is quite similar to the former embodiment shown in FIG. 3, except that there are two flexible transparent membrane windows (3, 9). To obtain a lens with a given OTF (for example a given focal length), the deformation or the curvature of the two membranes (3,9) may be only half on a per membrane basis of the deformation that would be necessary for only a single flexible transparent membrane window (3) to achieve the same OTF.

The FIG. 6 shows a compound lens according to the invention. In addition to the elements already described with reference to the FIG. 3, the chamber (4) is extended. On the left side of the drawing, we have the embodiment of the FIG. 3. On the right side, we have a complementary fluid-based lens with similar construction and characteristics. This configuration gives greater degrees of design freedom, as we shall see below.

Starting from the left, we have the same (planar) input window (5), forming a part of the fluid chamber (4). On the right side, we have a symmetrical construction, including a (planar) output window (8), also forming a part of the fluid chamber (4).

Inside the chamber (4), on the left, there is a first transparent fluid (1) having a first index of refraction n₁. On the left, there is a second transparent fluid (2) having a second index of refraction n₂. In between these two fluids (1,2), there is the transparent flexible membrane window (3) that is deformed due to the fluid pressures on its two sides.

In this embodiment, Snell's law determines the behavior of light at the interface between the fluids. In particular, the optical properties of such a lens are determined by the refractive indexes n₁ and n₂ of the two fluids and the shape of the transparent flexible membrane which determines that interface shape, i.e., the shape of the refractive lens surface.

A fluid fill port 6 may be provided for the fluid(s) on one or both sides of the chamber. Such fluid fill port(s) allow the injection or extraction of the two fluids (1,2) under command of the external control system (7) thereby providing a way to change the fluid pressure on one or both sides of the transparent flexible membrane window (3). A separate external control system (not shown) may be optionally added for the part of the chamber containing the second fluid (2), i.e., a liquid or a gas. Also, a separate reservoir (not shown) may optionally be added for each fluid if it is desirable to be able to vary the amount of the fluid(s) in the chamber in real time.

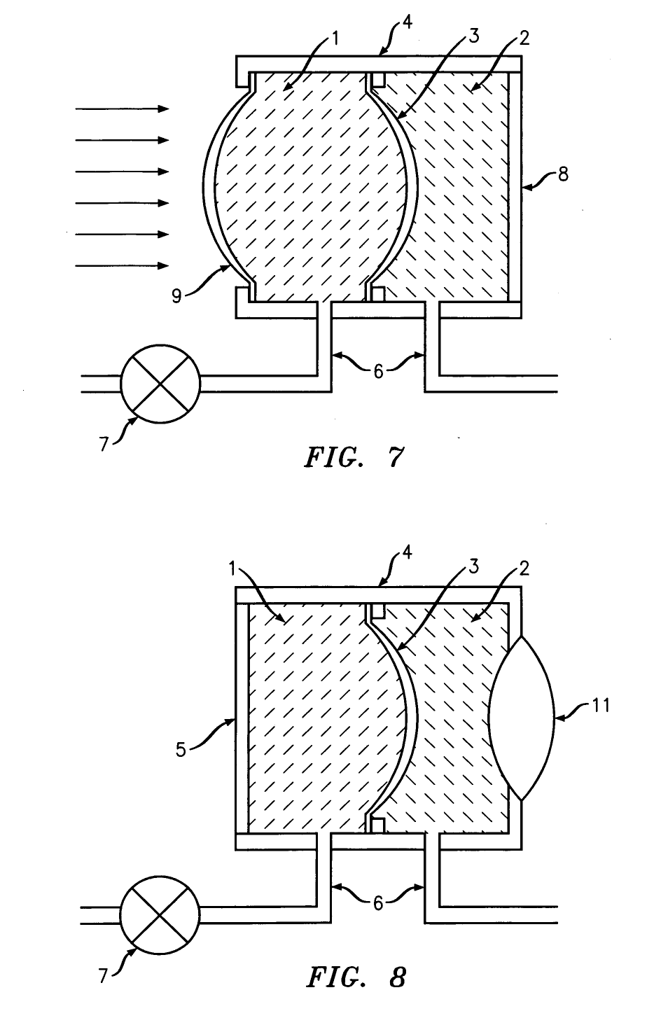

FIG. 7 shows another embodiment of a mechanical lens having two flexible transparent membranes (3, 9). Other embodiments of mechanical lenses (not shown) could have three flexible transparent membranes. In such embodiments, the third transparent flexible membrane replaces the rigid transparent planar window (8) in the other illustrated embodiments.

FIG. 8 shows a similar embodiment, wherein one of the exterior windows is a bulk refractive or reflective passive optical device, e.g., a convex or concave lens (11), rather than a planar window.

Another embodiment could combine the flexible transparent membrane on one side, as shown in FIG. 7, and a rigid refractive or reflective passive optical device as shown in FIG. 8 on the other side. Still another embodiment could have two rigid refractive or reflective passive optical devices on both ends of the chamber, with the flexible transparent membrane (3) in between the two fluids (1,2) of different refractive indices as discussed above (not shown).

Each of the above embodiments includes at least one flexible transparent membrane, e.g., an elastic membrane, which may be concave or convex depending on the fluid pressure applied to one or both sides thereof. In the case of more than one flexible transparent membrane, each such membrane may take either a concave shape or a convex shape depending on the fluid pressure(s) applied thereto.

In other embodiments, the volume of the internal cavity of the rigid chamber (4) may be varied to change the pressure of the transparent fluid (1). Such a manner of changing the fluid pressure can also be used to vary the shape of the transparent flexible membrane window(s) (3, 5) and thus, can be used to vary the focal length of the mechanical lens of FIGS. 1, 5, and 6.

Although individual optical systems are described here this does not preclude them from being arranged in one or two dimensional arrays, as would be obvious to those skilled in the art The invention is intended to include other embodiments that would be obvious to a person of ordinary skill in the art in light of the description, figures, and claims.

What is claimed is:

1. A mechanical lens, comprising:
a rigid chamber;
a first transparent window located to close one end of the chamber;
a flexible transparent membrane window being located to close another end of the chamber and being along an optical path of light received through said first transparent window; and
a transparent fluid having an index of refraction; and
wherein the chamber is filled with said fluid and a curvature of said flexible transparent membrane window is responsive to a pressure of said transparent fluid.

2. The mechanical lens of claim 1, wherein the chamber includes a port for introducing said fluid into said rigid chamber or extracting said fluid from said rigid chamber.

3. The mechanical lens of claim 1, further comprising a control system capable of changing a pressure of the fluid in said chamber.

4. The mechanical lens of claim 2, comprising a control system able to change a shape of said transparent membrane window by introducing fluid into said chamber via said port or extracting fluid from said chamber via said port.

5. The mechanical lens according to claim 2, further comprising a reservoir for containing liquid extracted from said chamber via said port or to be injected into said chamber via said port.

6. The mechanical lens according to claim 1, wherein said first transparent window is a second flexible transparent membrane window having a shape responsive to a pressure of said fluid.

7. The mechanical lens according to claim 6, further comprising external control system capable of adjusting curvatures of the windows by introducing fluid into said chamber via said port or extracting fluid from said chamber via said port

8. The mechanical lens according to claim 1, wherein the fluid is a liquid.

9. The mechanical lens according to claim 8, wherein the first window faces the transparent window.

10. The mechanical lens according to claim 1, wherein said transparent window is a lens.

11. A mechanical lens, comprising
a rigid chamber;
a first transparent window located at one end of the chamber;
a second transparent window located at another end of the chamber;
a first transparent fluid having an index of refraction;
a second transparent fluid having a different index of refraction; and
a flexible transparent membrane window being inside said rigid chamber between said first and second transparent windows; and
wherein said first transparent fluid fills a part of the chamber between said first window and said flexible transparent membrane window and said second transparent fluid fills a part of the chamber between said second window and said flexible transparent membrane window.

12. The mechanical lens of claim 11, wherein a curvature of said flexible transparent membrane window is responsive to a pressure of said first transparent fluid and is responsive to a pressure of said second fluid.

13. The mechanical lens of claim 11, wherein the chamber has ports for introducing said first and second fluids into said rigid chamber.

14. The mechanical lens according to claim 11, wherein said first and second transparent windows are rigid planar windows.

15. The mechanical lens according to claim 11, wherein one of said transparent windows is a rigid planar window and the other of said transparent windows is a glass lens.

16. The mechanical lens according to claim 11, wherein said transparent windows are lenses.

17. The mechanical lens according to claim 11, wherein one of said transparent windows is a rigid planar window and the other of said transparent windows is a flexible transparent membrane window.

18. The mechanical system lens according to claim 11, wherein both of said transparent windows are flexible transparent membrane windows.
